(19) United States
(12) Patent Application Publication
(10) Pub. No.: US 2007/0059230 A1
(43) Pub. Date: Mar. 15, 2007

(54) Process

(75) Inventors: Helene Audrain, Aarhus (DK); Dirk Bender, Aarhus (DK); Christophe Plisson, Cambridge (GB)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(73) Assignee: GLAXO GROUP LIMITED

(21) Appl. No.: 10/567,524

(22) PCT Filed: Aug. 5, 2004
(86) PCT No.: PCT/EP04/08830

§ 371 Date: Oct. 12, 2006

(30) Foreign Application Priority Data
Aug. 8, 2003 (GB) 0318728.3
Jul. 19, 2004 (GB) 0416141.0

(51) Int. Cl. C01B 35/10

(52) U.S. Cl. 423/277

(57) ABSTRACT

A process for preparing radiolabelled compounds by incorporation of radioactive carbonyl groups into precursors, which are then used to make the radiolabelled compounds. These radiolabelled compounds have a number of uses including in vivo imaging techniques such as positron emission tomography.

### FIELD OF THE INVENTION

The present invention relates to a process for preparing radiolabelled compounds. More specifically, the present invention relates to a process for preparing radiolabelled compounds, which involves incorporation of radioactive carbonyl groups into precursors, which are then used to make the radiolabelled compounds. These radiolabelled compounds have a number of uses including in vivo imaging techniques such as positron emission tomography.

### BACKGROUND OF THE INVENTION

Positron emission tomography (PET) is a non-invasive imaging technique that offers high spatial and temporal resolution and allows quantification of tracer concentrations in tissues. The technique involves the use of radiotracers labelled with positron emitting radionuclides, which permit measurement of parameters regarding the physiology or biochemistry of a variety of living tissues.

Compounds can be labelled with positron or gamma emitting radionuclides. The most commonly used positron emitting (PET) radionuclides are ¹¹C, ¹⁸F, ¹⁵O and ¹³N, which are accelerator produced, and have half lives of 20.4, 109.8, 2 and 10 minutes respectively. Due to their short half-lives ¹¹C, ¹⁵O and ¹³N labelled radiopharmaceuticals have to be use at the site of production and require the development of specific synthetic procedures.

¹¹C (T_{1/2}=20.4 min) is an important neutron-deficient radionuclide for PET because it can substitute for non-radioactive carbon in any organic molecule without altering their biological and physiochemical properties. An important part of the elaboration of new procedures to incorporate PET radionuclides into molecules is the development and handling of new ¹¹C labelled precursors.

¹¹C can be produced in the absence of the naturally occurring stable isotopes ¹²C and ¹³C, and with high yields on a small proton accelerator using the ¹⁴N(p,α)¹¹C reaction in a target gas containing nitrogen (Christman, et al., 1975; Clark, et al., 1975 and Welch et al., 1968). In the presence of oxygen trace (e.g. 0.1% oxygen), the radiochemical species formed is [¹¹C]carbon dioxide which is suitable for use directly as in the ¹¹C-carboxylation of Grignard reagents (organomagnesium halides). [¹¹C]carbon dioxide can also be converted into a variety of secondary radiolabelled chemical entities such as high specific activity [¹¹C]methyl iodide.

An important consideration for radiolabelling with carbon-11 is the maximization of specific activity of the radiolabelled compound. Isotopic dilution of [¹¹C]carbon dioxide with atmospheric carbon dioxide (3.4×10⁴ ppm) substantially reduces its specific activity and therefore limits the application of the resultant radiolabelled compound as a PET probe.

As an alternative method to using [¹¹C]carbon dioxide for radiolabelling compounds, [¹¹C]carbon monoxide may be used instead, as it is less prone to isotopic dilution with atmospheric carbon monoxide (0.1 ppm). Methods for the production of [¹¹C]carbon monoxide by reducing [¹¹C]carbon dioxide using reducing metals at high temperatures are well known (Gmelins 1972; Clark, et al., 1975; Zeisler, et al., 1997). Zinc and molybdenum are the most widely used reducing agent for the [¹¹C]carbon dioxide/carbon monoxide conversion.

However, it is difficult to trap ¹¹CO in the small volume of organic solvent in which most of the precursors for the production of radiolabelled compounds are soluble. Small volumes of solvent are required because this allows easy isolation of the radiolabelled product by means of preparative HPLC and increases the concentration of the starting materials in the reaction mixture, thereby forcing the reaction in the desired direction.

In 1978 Roeda, et al., described a method for the production of [¹¹C]phosgene from [¹¹C]carbon monoxide however, its practical use in the production of radiopharmaceuticals has been very limited due low yields and the lack of suitable equipment and methods to efficiently trap and react carbon monoxide.

Existing methods for the trapping of [¹¹C]carbon monoxide for the production of radiolabelled compounds rely on the use of high pressure or recirculation of [¹¹C]carbon monoxide to maintain adequately high levels of [¹¹C]carbon monoxide in solution (Kihlberg, et al., 1999; Hostetler, et al., 2002). This requires the use of dedicated automated robotic systems for the handling of [¹¹C]carbon monoxide and specialised equipment.

Borane carbonyl (H₃BCO) is the immediate precursor to boranocarbonates, such as the potassium salt K₂[H₃BCO₂] which were reported to release CO in water at elevated temperatures in 1967 (Malone et al., 1967; Malone et al., 1967a). Although yields of the solid, air stable K₂[H₃BCO₂], produced from the known methods of B₂H₆+CO are good, it is not convenient to work under pressurised conditions with H₃B.CO, as it is a pyrophoric gas (Carter, et al., 1965; Mayer, 1971). Alberto et al., (2001) found that by preparing H₃B.CO from commercially available H₃B.THF and reacting it in situ with an alcoholic solution of potassium hydroxide, K₂[H₃CO₂] could be produced at ambient pressures. This result was achieved by controlling the equilibrium of the two-way reaction between H₃BCO and H₃B.THF by selectively condensing the THF out of the reaction. The resultant K₂[H₃CO₂] was then used as an in situ source of CO in aqueous solution and as a reducing agent.

It has now been found that radiolabelled H₃B.CO can be used to release radiolabelled carbon monoxide in organic solvents, aqueous solvents and mixtures of organic and aqueous solvents in order to prepare radiolabelled compounds without the need for high pressure autoclaves or recirculation units.

### BRIEF SUMMARY OF THE INVENTION

Accordingly, in a first aspect the invention provides a process for the preparation of radiolabelled H₃B.CO comprising contacting H₃B in a suitable solvent with carbon monoxide and a suitable base, characterised in that the carbon monoxide is radiolabelled.

Radiolabelled H₃B.CO may be prepared by the reaction of borane (H₃B) in a suitable solvent with radiolabelled carbon monoxide. Suitable solvents for this reaction are those which solubilize H₃B and allow it to co-ordinate with free electron pairs of the oxygen, for example tetrahydrofuran (THF) and ethers such as diethyl ether and dioxane. THF is preferred as a solvent due to its physical characteristics of a high boiling point, a lower affinity towards water and its comparable low price.

Hydrides of other elements, such as aluminium gallium, indium and thallium hydride would also be expected to co-ordinate with radiolabelled carbon monoxide. However, the instability of aluminium hydride in solvents suitable for this reaction means that if an aluminium compound were to be used it would preferably be compounds such as AlCl₃ in THF or aluminium tri organyls.

Free solvent may be removed from the reaction by condensation or other suitable means such as a solid support. This achieves the advantage of shifting the equilibrium of the reaction towards increased production of radiolabelled H₃B.CO.

The carbon monoxide used in the reaction may be labelled by any conventional method with any of the following isotopes ¹¹C, ¹³C, ¹⁴C, ¹⁵O or ¹⁸O. Preferably ¹¹C is used.

Suitable solvents for use in the process of the invention include ethers such as diethyl ether and dioxane, and tetrahydrofuran. Preferably tetrahydrofuran is used. Suitable mixtures of solvents may also be used.

In a second aspect the invention provides the use of radiolabelled H₃B.CO prepared according to the first aspect of the invention, as a donor of radiolabelled carbon monoxide in the manufacture by carbonylation of radiolabelled compounds.

In practice the second aspect of the invention may be carried out by using the radiolabelled H₃B.CO prepared according to the first aspect of the invention in a coupling reaction as set out in Scheme 1 below, in which coupling reactions are typically carried out with a halide or a triflate (trifluoromethanesulfonate) with a nucleophile (alcohol, amine, thiol) or a organostannane, a base and a catalyst such as a palladium(0) catalyst to obtain esters, amides, ketones, aldehydes, carboxylic thioesters or by reacting a nitro component or an azido derivative to form isocyanate derivatives or condensing two nucleophiles in presence of selenium to synthesized carbamates, thiocarbamates, carbonates and ureas.

Suitable bases for use in the process of the invention include triethylamine (TEA), N-Methyldibutylamine (MDBA), M-Methyl-2,2,6,6-tetramethylpiperidine (N-MTMP) and N,N-di-isopropyl-ethylamine (DIPEA). Suitable mixtures of bases may also be used.

The starting materials and reagents for use in the first and second aspects of the invention are available commercially or can be synthesised by well-known and conventional methods. The reaction conditions used in the formation of non-radiolabelled H₃B.CO can be sourced from Alberto et al., (2001), other reaction conditions such as the radiolabelling of CO and carbonylation reactions are well known.

[¹¹C]CO, prepared by reduction of [¹¹C]CO₂ with a reducing metal (commonly zinc or molybdenum), is trapped using conventional methods such as molecular sieves in liquid nitrogen or silica and is then carried into a solution of BH₃.THF using an inert gas carrier. The [¹¹C]borane carbonyl ([¹¹C] H₃B.CO) complex thus formed is then carried through to a reaction chamber in which it is reacted with suitable components to construct the required compound using conventional coupling methods. Conventional coupling reaction often take place at elevated temperatures and the reaction chamber may be made of materials suitable for use in a microwave (such as glass).

In order to promote the formation of the [¹¹C]borane carbonyl THF is removed from the reaction, typically by condensation. Coupling reactions are typically carried out reacting [¹¹C]borane carbonyl with the appropriate starting materials and reagents as depicted in scheme 1.

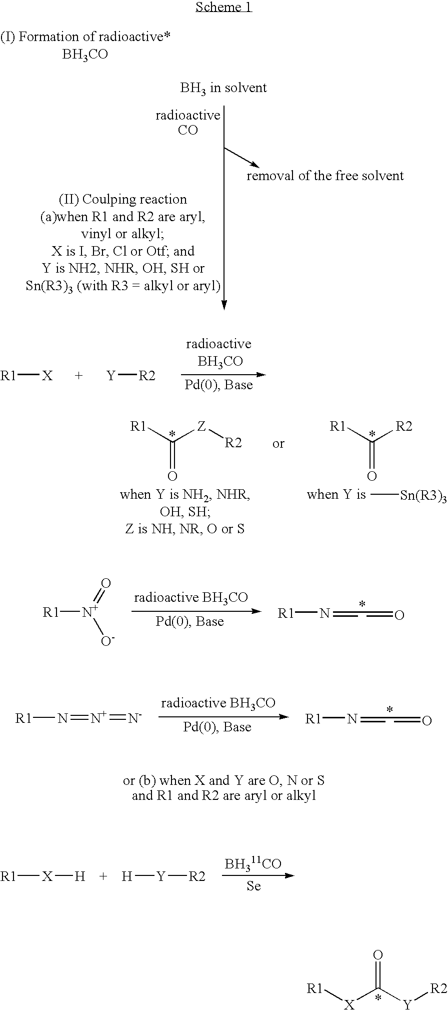

Suitable compounds for radiolabelling by this method are those which contain a carbonyl group (some examples are shown in Scheme 2).

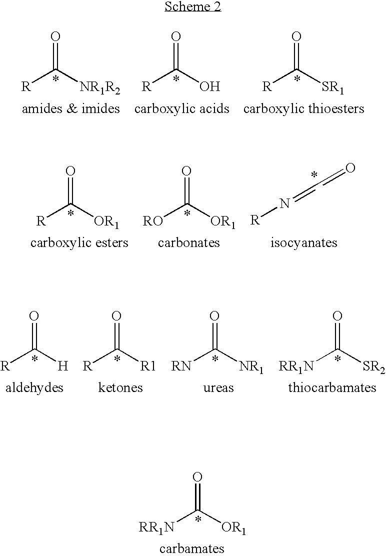

Amides and imides can also contain lactams and carboxylic esters can also contain lactones.

In a third aspect the invention provides radiolabelled H₃B.CO prepared in accordance with the first aspect of the invention.

In fourth aspect the invention provides radiolabelled compounds prepared by carbonylation in accordance with the second aspect of the invention.

Edidepride (N-((S)-1-Ethyl-pyrrolidin-2-ylmethyl)-3-iodo-5-methoxy-benzamide), FLB (5-bromo-N-((S)-1-ethyl-pyrrolidin-2-ylmethyl)-2,3-dimethoxy-benzamide) and raclopride (3,5-dichloro-N-((S)-1-ethyl-pyrrolidin-2-ylmethyl)-2-hydroxy-6-methoxy-benzamide), which are all dopamine D2 ligands and PK11195 (1-(2-Chloro-phenyl)-isoquinoline-3-carboxylic acid), which is a benzodiazepine receptor ligand are commonly used PET ligands that contain carbonyl groups that can be labelled with [¹¹C]CO.

In a fifth aspect the invention provides use of the radiolabelled compounds according to the fourth aspect of the invention in imaging techniques such as positron emission tomography, modified single photon emission tomography and autoradiography (classical and phosphor imaging plates).

In a sixth aspect the invention provides a composition comprising a radiolabelled compound in accordance with the fourth aspect of the invention and a pharmaceutically acceptable carrier or carriers, suitable for use in the above mentioned imaging techniques.

### DETAILED DESCRIPTION OF THE INVENTION

The invention is further described through the following examples:

### EXAMPLES

Abbreviation List:

THF: Tetrahydrofuran
TEA: Triethylamine
DBU: 1,8-Diazabicyclo[5.4.0]undec-7-ene
TMP: Tetramethylpiperidine
DMF: Dimethylformamide
DIPEA: N,N-di-isopropyl-ethylamine
MDBA: N-Methyldibutylamine
N-MTMP: M-Methyl-2,2,6,6-tetramethylpiperidine

### Synthesis of [¹¹C]N-benzyl-benzamide (I)

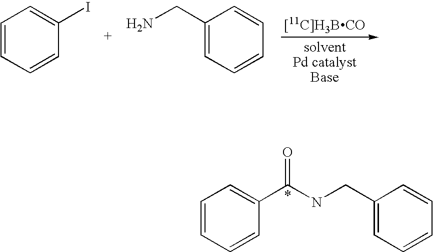

### Example 1

Preparation of the Reaction Vial

Palladium(II) diacetate (0.5 mg, 0.0022 mmol) and triphenylphosphine (2.9 mg, 0.011 mmol) were dissolved in 700 μL THF (degassed by bubbling N₂ through it for few minutes). Then, iodobenzene (1.5 mg, 0.00735 mmol) and benzylamine (1.2 mg, 0.011 mmol) dissolved in 300 μL THF (degassed by bubbling N₂ through it for few minutes) were added to the solution of palladium complex. TEA (1.6 μL, 0.0088 mmol) was added, and the reaction vial was placed in the reaction-setup in a bath at −78° C.

Synthesis

[¹¹C]Carbon dioxide was produced by the ¹⁴N(p,α)¹¹C nuclear reaction using a nitrogen gas target (containing 1% oxygen) pressurised to 150 psi and bombarded with 16 MeV protons using the General Electric Medical Systems PETtrace 200 cyclotron. Typically, the irradiation time was 30 minutes using-a 40 μA beam current. After irradiation, [¹¹C]carbon dioxide was trapped and concentrated on 4 Å molecular sieves. The trapped [¹¹C]CO₂ was released from molecular sieves in a stream of nitrogen (30 mL/min) by heating them to 350° C. [¹¹C]CO₂ was reduced on-line to [¹¹C]carbon monoxide after passing through a quartz tube filled with zinc granular heated to 400° C. The produced [¹¹C]carbon monoxide was transferred in our system set-up at 30 mL/min, where it was condensed on 4 Å molecular sieves at −196° C. After 6 min delivery and trapping of the [¹¹C]CO, the radioactive gas was then released at room temperature in a flow of nitrogen (6 mL/min) to bubble through a BH₃.THF solution (1.5 mL of a 1.0 M solution) in order to make the [¹¹C]BH₃.CO complex. This complex was carried with the flow of nitrogen through an empty vial cooled at −60° C. to remove the THF, and finally through the reaction vial containing the reactants (cf. preparation of the reaction vial above) cooled at −78° C. The trapping process took approximately 6 min (when the radioactivity level measured in the reaction vial has reached a maximum). The delivery tubings were then removed and the reaction vial heated in an oven at 110° C. for 10 min. The crude product was filtered through a 0.45 μm filter and analysed using analytical radio HPLC.

Analytical HPLC was performed using a Dionex system (SUMMIT HPLC system), equipped with a Dionex HPLC pump (Model P 680A LPG) with a 200 μl injection loop connected in series with a Phenomenex Sphereclone 5u ODS(2) column (250×4.60 mm, 5 μm), a variable Dionex UV/VIS detector (Type UVD 170U/340U) in series with a sodium iodide radiodetector of in-house design.

The desired end-product was identified by co-injection with a non-radioactive reference. The given yields of the product are based on the final radioactivity trapped in the reaction vial at EOS (End Of Synthesis).

The analytical HPLC showed the formation of the desired radiolabelled [¹¹C]N-benzylbenzamide in Example 1 in approximately 1.7% yield.

### Example 2

The synthesis of [¹¹C]N-benzyl-benzamide was carried out as described in Example 1 except that the palladium(II) diacetate (0.5 mg, 0.0022 mmol) and triphenylphosphine (2.9 mg, 0.011 mmol) were dissolved in 700 μL of a solution of THF:H₂O, 4:1 (degassed by bubbling N₂ through it for few minutes), the iodobenzene (1.5 mg, 0.00735 mmol) and benzylamine (1.2 mg, 0.011 mmol) were dissolved in 300/L of a solution of THF:H₂O, 4:1 (degassed by bubbling N₂ through it for few minutes). The reaction vial was placed in the reaction-setup in a bath at 0° C. and after the trapping of the [¹¹C]BH₃.CO the reaction vial was heated at 120° C. for 8 min, filtered and analysed for radioactivity content. The analysis of the HPLC chromatograms showed the formation of the desired radiolabelled [¹¹C]N-benzylbenzamide in approximately 7% yield.

### Example 3

The synthesis of [¹¹C]N-benzyl-benzamide was carried out as described in Example 1 except that the palladium(II) diacetate (0.5 mg, 0.0022 mmol) and triphenylphosphine (2.9 mg, 0.011 mmol) were dissolved in 700 μL of a solution of THF+2% H₂O (degassed by bubbling N₂ through it for few minutes), the iodobenzene (1.5 mg, 0.00735 mmol) and benzylamine (1.2 mg, 0.011 mmol) were dissolved in 300 μL of a solution of THF+2% H₂O (degassed by bubbling N₂ through it for few minutes) and after the trapping of the [¹¹C]BH₃.CO, the reaction vial was heated at 120° C. for 8 min, filtered and analysed for radioactivity content. The analysis of the HPLC chromatograms showed the formation of the desired [¹¹C]N-benzylbenzamide in approximately 30% yield.

### Example 4

The synthesis of [¹¹C]N-benzyl-benzamide was carried out as described in Example 1 except that the palladium(II) diacetate (0.5 mg, 0.0022 mmol) and triphenylphosphine (2.9 mg, 0.011 mmol) were dissolved in 700 μL of a solution of THF+1% H₂O (degassed by bubbling N₂ through it for few minutes), the iodobenzene (1.5 mg, 0.00735 mmol) and benzylamine (1.2 mg, 0.011 mmol) were dissolved in 300 μL of a solution of THF+1% H₂O (degassed by bubbling N₂ through It for few minutes) and after the trapping of the [¹¹C]BH₃.CO the reaction vial was heated at 50° C. for 8 min, filtered and analysed for radioactivity content. The analysis of the HPLC chromatograms showed the formation of the desired [¹¹C]N-benzylbenzamide in approximately 17% yield.

### Example 5

The synthesis of [¹¹C]N-benzyl-benzamide was carried out as described in Example 4 except that after the trapping of the [¹¹C]BH₃.CO, the reaction vial was heated at 70° C. for 8 min, filtered and analysed for radioactivity content. The analysis of the HPLC chromatograms showed the formation of the desired [¹¹C]N-benzylbenzamide in approximately 47% yield.

### Example 6

The synthesis of [¹¹C]N-benzyl-benzamide was carried out as described in Example 4 except that after the trapping of the [¹¹C]BH₃.CO, the reaction vial was heated at 85° C. for 8 min, filtered and analysed for radioactivity content. The analysis of the HPLC chromatograms showed the formation of the desired [¹¹C]N-benzylbenzamide in approximately 47% yield.

### Example 7

The synthesis of [¹¹C]N-benzyl-benzamide was carried out as described in Example 4 except that after the trapping of the [¹¹C]BH₃.CO, the reaction vial was heated at 120° C. for 8 min, filtered and analysed for radioactivity content. The analysis of the HPLC chromatograms showed the formation of the desired [¹¹C]N-benzylbenzamide in approximately 47% yield.

### Example 8

The synthesis of [¹¹C]N-benzyl-benzamide was carried out as described in Example 4 except that after the trapping of the [¹¹C]BH₃.CO, the reaction vial was heated at 140° C. for 8 min, filtered and analysed for radioactivity content. The analysis of the HPLC chromatograms showed the formation of the desired [¹¹C]N-benzylbenzamide was approximately 28% yield.

### Example 9

The synthesis of [¹¹C]N-benzyl-benzamide was carried out as described in Example 5 except that DBU (1.3 μL, 0.0016 mmol) was used instead of TEA. The analysis of the HPLC chromatograms showed traces of the formation of the desired [¹¹C]N-benzylbenzamide.

### Example 10

The synthesis of [¹¹C]N-benzyl-benzamide was carried out as described in Example 5 except that 2,2,6,6-TMP (1.7 μL, 0.009 mmol) was used instead of TEA. The analysis of the HPLC chromatograms showed the formation of the desired [¹¹C]N-benzylbenzamide in approximately 8% yield.

### Example 11

The synthesis of [¹¹C]N-benzyl-benzamide was carried out as described in Example 5 except that pyridine (0.7 μL, 0.0088 mmol) was used instead of triethylamine and the reaction vial was heated from 40 to 80° C. for 15 min, filtered and analysed for radioactivity content. The analysis of the HPLC chromatograms showed the formation of the desired [¹¹C]N-benzylbenzamide in approximately 28% yield.

### Example 12

The synthesis of [¹¹C]N-benzyl-benzamide was carried out as described in Example 5 except that benzylamine (3.6 mg, 0.034 mmol) was used instead of TEA and the reaction vial was heated 90° C. for 8 min, filtered and analysed for radioactivity content. The analysis of the HPLC chromatograms showed the formation of the desired [¹¹C]N-benzylbenzamide in approximately 20% yield.

### Example 13

The synthesis of [¹¹C]N-benzyl-benzamide was carried out as described in Example 4 except that the palladium(II) diacetate, triphenylphosphine, iodobenzene and benzylamine benzylamine were dissolved in DMF, and after the addition of TEA the reaction vial was placed in the reaction-setup in a bath at −50° C. After the trapping of the [¹¹C]BH₃.CO the reaction vial was heated at 90° C. for 8 min, filtered and analysed for radioactivity content. The analysis of the HPLC chromatograms showed the formation of the desired [¹¹C]N-benzylbenzamide in approximately 23% yield.

### Example 14

The synthesis of [¹¹C]N-benzyl-benzamide was carried out as described In Example 4 except that the palladium(II) diacetate, triphenylphosphine, iodobenzene and benzylamine benzylamine were dissolved in 1,2-dichloroethane, and after the addition of TEA the reaction vial was placed in the reaction-setup in a bath at −20° C. After the trapping of the [¹¹C]BH₃.CO the reaction vial was heated at 110° C. for 8 min, filtered and analysed for radioactivity content. The analysis of the HPLC chromatograms showed the formation of the desired [¹¹C]N-benzylbenzamide in approximately 12% yield.

### Example 15

Preparation of the Reaction Vial

Preparation of the reaction vial was carried out as described in Example 1 except that the palladium (II) diacetate (0.5 mg, 0.0022 mmol) and triphenylphosphine (2.9 mg, 0.11 mmol) were dissolved in 700 μL THF with 1% H₂O and the iodobenzene (1.5 mg, 0.00735 mmol) and benzylamine (1.2 mg, 0.011 mmol) were dissolved in 300 μL degassed THF with 1% H₂O.

Synthesis

Synthesis of [¹¹C]N-benzyl-benzamide was carried out as described in Example 1 except that the produced [¹¹C]CO was condensed onto a trap at −196° C. made from a 12-inch coil of 1/16″ stainless steel tubing, 0.040″ i.d., packed with carbonex 1000, 45/60 mesh (Supelco). After 6 min delivery and trapping of the [¹¹C]CO, the radioactive gas was then released at room temperature and carried out through an empty vial in a flow of nitrogen (6 mL/min) into a reactor loaded with the BH₃.THF solution (1.5 mL of a 1.0 M solution in THF) in order to form the [¹¹C]BH₃.CO complex. The complex was then carried with the flow of nitrogen through an empty vial cooled at −78° C., and finally through the reaction vial containing the reactants cooled at −78° C. After 6 min of delivery of the [¹¹C]BH₃.CO complex the tubings were removed and the reaction vial heated in an oven at a temperature o 95° C. for 10 min. The crude product was filtered through a 0.45 μm filter and analysed for radioactivity Content The analysis of the HPLC chromatograms showed the formation of the desired [¹¹C]N-benzylbenzamide in approximately 47% yield.

### Example 16

The synthesis of [¹¹C]N-benzyl-benzamide was carried out as described in Example 15 except that the TEA was replaced with DIPEA (1.53 μL, 0.0088 mmol) and the reaction vial containing the [¹¹C]BH₃.CO complex was heated in an oven at 90° C. for 10 min, filtered and analysed for radioactivity content The analysis of the HPLC chromatograms showed the formation of the desired [¹¹C]N-benzylbenzamide in approximately 91% yield

### Synthesis of [¹¹C]phthalide

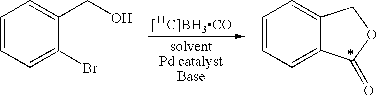

### Example 17

Tetrakis(triphenylphosphine)palladium(0) (1.1 mg, 0.95 μmol) was dissolved in 500 μL of a solution of THF+1% H₂O (degassed by bubbling N₂ through it for few minutes). Then, a mixture of 2-bromobenzyl alcohol (1.1 mg, 0.006 mmol) and K₂CO₃ (5 mg, 0.036 mmol) were dissolved in 300 μL of THF+1% H₂O (degassed by bubbling N₂ through it for few minutes) and added to the solution of the palladium complex. The reaction vial was placed in the reaction-setup in a bath at −78° C. After the trapping of the [¹¹C]BH₃.CO as described in Example 1, the reaction was heated at 100° C. for 4 min, filtered and analysed for radioactivity content The analysis of the HPLC chromatograms showed the formation of the desired [¹¹C]phthalide in traces.

### Example 18

Palladium(II) diacetate (0.8 mg, 0.0035 mmol) and triphenylphosphine (5 mg, 0.020 mmol) were dissolved in 700 μL of a solution of THF+1% H₂O (degassed by bubbling N₂ through it for few minutes). Then, a mixture of 2-bromobenzyl alcohol (2.2 mg, 0.012 mmol) and K₂CO₃ (5 mg, 0.036 mmol) were dissolved in 300 μL of THF+1% H₂O (degassed by bubbling N₂ through it for few minutes) and added to the solution of the palladium complex. The reaction vial was placed in the reaction-setup in a bath at −78° C. After the trapping of the [¹¹C]BH₃.CO as described in Example 1, the reaction was heated at 120° C. for 5 min, filtered and analysed for radioactivity content. The analysis of the HPLC chromatograms showed the formation of the desired [¹¹C]phthalide in traces.

### Example 19

Palladium(II) diacetate (0.8 mg, 0.0035 mmol) and triphenylphosphine (5 mg, 0.020 mmol) were dissolved in 700 μL of a solution of THF (degassed by bubbling N₂ through it for few minutes). Then, a mixture of 2-bromobenzyl alcohol (2.2 mg, 0.012 mmol) and DBU (2.0 μL, 0.014 mmol) was dissolved in 300 μL of THF (degassed by bubbling N₂ through it for few minutes) and added to the solution of the palladium complex. The reaction vial was placed in the reaction-setup In a bath at −78° C. After the trapping of the [¹¹C]BH₃.CO as described in Example 1, the reaction was heated at 110° C. for 5 min, filtered and analysed for radioactivity content. The analysis of the HPLC chromatograms showed the formation of the desired [¹¹C]phthalide in traces.

### Example 20

Palladium(II) diacetate (0.8 mg, 0.0035 mmol) and triphenylphosphine (5 mg, 0.020 mmol) were dissolved in 700 μL of a solution of THF (degassed by bubbling N₂ through it for few minutes). Then, a solution of 2-bromobenzyl alcohol (2.2 mg, 0.012 mmol) in 300 μL of THF (degassed by bubbling N₂ through it for few minutes) was added to the solution of the palladium complex. The reaction vial was placed in the reaction-setup in a bath at −78° C. After the trapping of the [¹¹C]BH₃.CO as described in Example 1, the reaction was heated at 120° C. for 5 min, filtered and analysed for radioactivity content. The analysis of the HPLC chromatograms showed the formation of the desired [¹¹C]phthalide in approximately 40% yield.

### Example 21

Palladium(II) diacetate (0.5 mg, 0.0022 mmol) and triphenylphosphine (2.9 mg, 0.011 mmol) were dissolved in 700 μL of a solution of THF+1% H₂O (degassed by bubbling N₂ through it for few minutes). Then, a mixture of 2-bromobenzyl alcohol (2.2 mg, 0.012 mmol) and TEA (1.9 μL, 0.014 mmol) were dissolved in 300 μL of THF+1% H₂O (degassed by bubbling N₂ through it for few minutes) and added to the solution of the palladium complex. The reaction vial was placed in the reaction-setup in a bath at −78° C. After the trapping of the [¹¹C]BH₃.CO as described in Example 1, the reaction was heated at 90° C. for 8 min, filtered and analysed for radioactivity content. The analysis of the HPLC chromatograms showed the formation of the desired [¹¹C]phthalide in approximately 26% yield.

### Example 22

Palladium(II) diacetate (1.0 mg, 0.0044 mmol) and triphenylphosphine (6 mg, 0.022 mmol) were dissolved in 700 μL of a solution of THF+1% H₂O (degassed by bubbling N₂ through it for few minutes). Then, a mixture of 2-bromobenzyl alcohol (2.2 mg, 0.012 mmol) and TEA (1.9 μL, 0.014 mmol) were dissolved in 300 μL of THF+1% H₂O (degassed by bubbling N₂ through it for few minutes) and added to the solution of the palladium complex. The reaction vial was placed in the reaction-setup in a bath at −78° C. After the trapping of the [¹¹C]BH₃.CO as described in Example 1, the reaction was heated at 90° C. for 8 min, filtered and analysed for radioactivity content. The analysis of the HPLC chromatograms showed the formation of the desired [¹¹C]phthalide in approximately 20% yield.

### Example 23

Palladium(II) diacetate (0.5 mg, 0.0022 mmol) and triphenylphosphine (2.9 mg, 0.011 mmol) were dissolved in 700/L of a solution of THF with 1% H₂O (degassed by bubbling N₂ through it for few minutes). Then, a mixture of 2-bromobenzyl alcohol (1.37 mg, 0.0073 mmol) and DIPEA (1.53 μL, 0.0088 mmol) were dissolved in 300 μL of THF with 1% H2O (degassed by bubbling N2 through it for few minutes) and added to the solution of the palladium complex. The reaction vial was placed in the reaction-setup in a bath at −78 C. The trapping of the [¹¹C]BH₃.CO complex was carried out as described in Example 15 and the reaction was heated at 95° C. for 10 min, filtered and analysed for radioactivity content. The analysis of HPLC chromatograms showed the formation of the desired [¹¹C]phthalide in approximately 40% yield.

### Example 24

The synthesis of [¹¹C]phthalide was carried out as described in Example 23 except that the reaction was heated at 95° C. for 8 min, filtered and analysed for radioactivity content. The analysis of the HPLC chromatograms showed the formation of the desired [¹¹C]phthalide in approximately 89% yield min

### Synthesis of [¹¹C]N-Methylnicotinamide

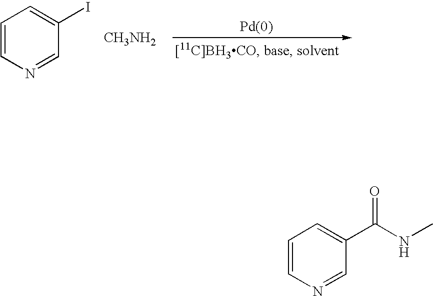

### Example 25

Palladium(II) diacetate (0.5 mg, 0.0022 mmol) and triphenylphosphine (2.9 mg, 0.011 mmol) were dissolved in 400 μL of a solution of THF with 1% H₂O (degassed by bubbling N₂ through it for 5 minutes). Then, a mixture of 3-iodopyridine (1.5 mg, 0.0073 mmol) and DIPEA (1.53 μL, 0.0088 mmol) were dissolved in 600 μL of methylamine 2.0 M in solution in THF and then added to the solution of the palladium complex. The reaction vial was placed in the reaction-setup in a bath at −78° C. After the trapping of the [¹¹C]BH₃.CO as described in Example 15, the reaction was heated at 140° C. for 8 min, filtered and analysed for radioactivity content. The analysis of the HPLC chromatograms showed the formation of the desired [¹¹C] N-Methylnicotinamide in approximately 95% yield

### Synthesis of [¹¹C]6-[(3-cyclobutyl-2,3,4,5-tetrahydro-1H-3-benzazepin-7-yl)oxy]-N-methylnicotinamide (WO 2004/056369)

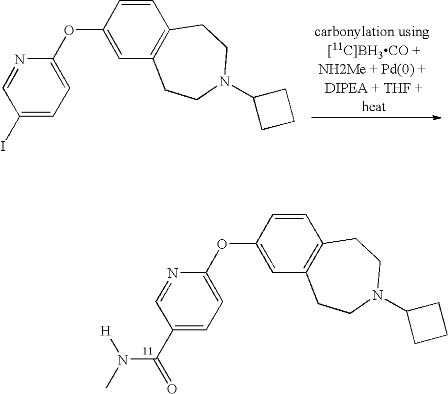

### Example 26

Palladium(II) diacetate (0.5 mg, 0.0022 mmol) and triphenylphosphine (2.9 mg, 0.011 mmol) were dissolved in 700 μL of a solution of THF with 1% H₂O (degassed by bubbling N₂ through it for 5 minutes). Then, a mixture of 3-cyclobutyl-7-[(5-iodo-2-pyridinyl)oxy]-2,3,4,5-tetrahydro-1H-3-benzazepine (3.1 mg, 0.0073 mmol), DIPEA (1.53 μL, 0.0088 mmol) and methylamine 2.0 M (0.011 mmol, 5.48 μL solution in THF) were dissolved in 300 μL of THF with 1% H₂O (degassed by bubbling N2 through it for 5 minutes) and added to the solution of the palladium complex. The reaction vial was placed in the reaction-setup in a bath at −78° C. After the trapping of the [¹¹C]BH₃.CO as described in Example 15, the reaction was heated at 100° C. for 8 min filtered and analysed for radioactivity content. The analysis of the HPLC chromatograms showed the formation of the desired [¹¹C]6-[(3-cyclobutyl-2,3,4,5-tetrahydro-1H-3-benzazepin-7-yl)oxy]-N-methylnicotinamide in approximately 6.5% yield.

### Example 27

Palladium(II) diacetate (0.5 mg, 0.0022 mmol) and triphenylphosphine (2.9 mg, 0.011 mmol) were dissolved in 400 μL of a solution of THF with 1% H₂O (degassed by bubbling N₂ through it for few minutes). Then, a mixture of 3-cyclobutyl-7-[(5-iodo-2-pyridinyl)oxy]-2,3,4,5-tetrahydro-1H-3-benzazepine (1.6 mg, 0.00365 mmol), DIPEA (1.53 μL, 0.0088 mmol) and methylamine 2.0 M (0.011 mmol, 5.48 μL solution in THF) were dissolved in 300 μL of THF with 1% H2O (degassed by bubbling N2 through it for 5 minutes) and added to the solution of the palladium complex. The reaction vial was placed in the reaction-setup in a bath at −78° C. After the trapping of the [¹¹C]BH₃.CO as described in Example 15, the reaction was heated at 140° C. for 8 min, filtered and analysed for radioactivity content. The analysis of the HPLC chromatograms showed the formation of the desired [¹¹C]6-[(3-cyclobutyl-2,3,4,5-tetrahydro-1H-3-benzazepin-7-yl)oxy]-N-methylnicotinamide in approximately 44.4% yield

### Example 28

### Synthesis of [¹¹C](4-(1-{4-[4-(3-Piperidin-1-yl-propoxy)-phenyl]-piperazin-1-yl}-methanoyl)-benzonitrile (WO 2004/035556)

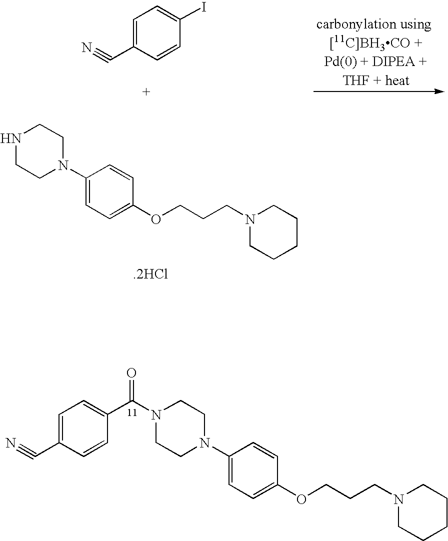

Palladium(II) diacetate (0.5 mg, 0.0022 mmol) and triphenylphosphine (2.9 mg, 0.011 mmol) were dissolved in 700 μL of a solution of THF with 1% H₂O (degassed by bubbling N₂ through it for 5 minutes). Then, a mixture of 1-(4-{[3-(1-piperidinyl)propyl]oxy}phenyl)piperazine (2.05 mg, 0.0055 mmol), DIPEA (1.86 μL, 0.011 mmol) and 4-iodo-benzonitrile (0.0036 mmol, 0.85 mg) were dissolved in 300 μL of THF with 1% H2O (degassed by bubbling N2 through it for 5 minutes) and added to the solution of the palladium complex. The reaction vial was placed in the reaction-setup in a bath at −78° C. After the trapping of the [¹¹C]BH₃.CO as described in Example 15, the reaction was heated at 140° C. for 7 min, filtered and analysed for radioactivity content. The analysis of the HPLC chromatograms showed the formation of the desired [[¹¹C](4-(1-{4-[4-(3-Piperidin-1-yl-propoxy)-phenyl]-piperazin-1-yl}-methanoyl)-benzonitrile in approximately 30% yield.

### REFERENCES

Alberto et al J. Am. Chem. Soc. (2001) 123, 3135-3136
Carter, J. C., Pary R. W., J. Am. Chem. Soc. (1965), 87, 2354-2358
Christman D. R., Finn R. D., Karistrom K. I. and Wolf A. P. (1975) Int. J. Appl. Radiat. Isot 26, 435-442
Clark, J. C. and Buckingham, P. D. (1975) Short-lived Radioactive Gases for Medical Use, p 231. Butterworths, London
Gmelins (1972) Handbuch der Anorganishen Chemie Vol. ‘Kohlenstoff’ C2, p. 203. Springer, Heidelberg
Hostetler, E. D. and Burns, H. D., Nucl. Med. Biol. (2002) 29, 845-848
Kihlberg, T., Bengt Langstrom T. B., J. Org. Chem. (1999) 64, 9201-9205
Malone L. J., Parry R. W., Inorg. Chem. (1967), 6, 817-822
Malone L. J., Inorg. Chem. (1967a), 6, 2260-2262
Mayer E., Monatsh. Chem. (1971), 102, 940-945
Roeda D., Crouzel C. and Van Zanten B (1978) Radiochem. Radioanal. Letts 33, 175-178
Welch M. J. and Ter-Pogossian M. M. (1968) Radiation Res. 36, 580-587)
Zeisler S. K., Nader M., Theobald A. and Oberdorfer F. (1997) Appl. Radiat. Isot. vol. 48, 1091-1095

What is claimed is:

1. A process for the preparation of radiolabelled H₃BCO comprising contacting H₃B in a suitable solvent with carbon monoxide, characterised in that the carbon monoxide is radiolabelled.

2. A process according to claim 1, wherein the process is carried out in the presence of a suitable base.

3. A process according to claim 1, wherein the production of radiolabelled H₃BCO is promoted by removal of free solvent from the mixture.

4. A process according to claim 3, wherein removal of free solvent from the mixture is promoted by condensation.

5. A process according to claim 1, wherein the solvent comprises any ether or tetrahydrofuran.

6. A process according to claim 1, wherein the solvent comprises diethyl ether, dioxane or tetrahydrofuran.

7. A process according to claim 1, wherein the solvent is tetrahydrofuran.

8. A process according to claim 1, wherein the base is triethylamine, N-Methyldibutylamine, M-Methyl-2,2,6,6-tetramethylpiperidine or N,N-di-isopropyl-ethylamine (DIPEA).

9. A process according to claim 1, wherein the carbon monoxide is radiolabelled with ¹¹C, ¹³C, ¹⁴C ¹⁵O or ¹⁸O.

10. A process according to claim 9, wherein the radiolabelled is ¹¹C.

11. A process for preparing radiolabelled compounds by carbonylation using radiolabelled H₃BCO prepared according to claim 1 as a donor of radiolabelled carbon monoxide.

12. A radiolabelled compound prepared using a process according to claim 11.

13. Use of a radiolabelled compound according to claim 12 in imaging techniques.

14. Use according to claim 13, wherein the imaging technique is selected from positron emission tomography, modified single photon emission tomography or autoradiography.

15. Use according to claim 14, wherein the imaging technique is selected from positron emission tomography.

16. A product of a process according to claim 1.

17. A composition comprising a radiolabelled compound according to claim 12.
